(19) United States
(12) Patent Application Publication
(10) Pub. No.: US 2025/0244229 A1
(43) Pub. Date: Jul. 31, 2025

(54) METHOD FOR PARAMETERIZING A PHOTOACOUSTIC DETECTOR

(71) Applicant: COMMISSARIAT A L’ÉNERGIE ATOMIQUE ET AUX ÉNERGIES ALTERNATIVES, Paris (FR)

(72) Inventors: Héloïse HANNART, Grenoble cedex 09 (FR); Kévin JOURDE, Grenoble cedex 09 (FR)

(73) Assignee: COMMISSARIAT A L’ÉNERGIE ATOMIQUE ET AUX ÉNERGIES ALTERNATIVES, Paris (FR)

(21) Appl. No.: 19/041,303

(22) Filed: Jan. 30, 2025

(30) Foreign Application Priority Data
Jan. 31, 2024 (FR) FR2400920

(51) Int. Cl. G01N 21/17

(52) U.S. Cl. CPC G01N 21/1702; G01N 2021/1704

(57) ABSTRACT

Method for parameterizing a photoacoustic detector, the photoacoustic detector comprising:
a measurement chamber (10), intended to be occupied by a gas;
a laser source (15), configured to illuminate the gas;
an acoustic transducer;
a processing unit (20), configured to demodulate each detection signal, according to a demodulation parameter, and to estimate the concentration of a target gas species,
   the method being characterized in that:
each illumination parameter and/or each demodulation parameter form acquisition parameters respectively associated with each detection signal;
the method comprises a parameterizing phase, implemented by the processing unit, making it possible to define at least one acquisition parameter so as to minimize a measurement error.

### TECHNICAL FIELD

The technical field of the invention is photoacoustic detection.

### PRIOR ART

Photoacoustic detection allows detection of a low concentration of a gas species, present in a gas or gas mixture, in trace amounts. The operating principle is based on periodic illumination of the gas at a wavelength corresponding to an absorption spectral band of the sought gas species. The illumination may be pulsed or more generally its amplitude and/or wavelength may be modulated, at a predetermined modulation frequency. The illumination results in periodic heating of the gas, the latter generating a pressure wave. The pressure wave is detected by an acoustic transducer. Thus, detection of the acoustic wave makes it possible to quantify a concentration of the gas species in the analysed gas. Photoacoustic detection allows compact gas sensors to be designed for use in the industrial or medical field.

Generally, the illumination is carried out at a wavelength in the near or medium-infrared domain, typically between 0.8 μm and 12 μm. These wavelengths correspond to (pure or compound) vibrational absorption by specific chemical bonds contained in the gas molecule(s) (for example: C—H, C—O, N—H, S—O, C—C, C—F, etc.). Visible or ultraviolet wavelengths are also used for gases that do not have an effective spectral response in the infrared range (use may be made, by way of example, of ozone, which absorbs most strongly in the UV-C band about 0.25 μm).

The illumination is amplitude-modulated and/or wavelength-modulated at a modulation frequency generally between 100 Hz and 50 kHz. The modulation frequency notably depends on the geometry of a measurement chamber occupied by the analysed gas. The wavelength of the illumination may be scanned, thereby allowing various gas species to be addressed in succession.

To determine the concentration of the gas species, a phase of demodulating the detection signal resulting from the photoacoustic transducer is required. The demodulation is performed using a harmonic, corresponding to the modulation frequency or to an integer multiple of the modulation frequency.

Generally, the parameters of modulation of the illumination and of demodulation of the signal resulting from the acoustic transducer are defined empirically. The inventors provide a way of determining modulation or demodulation parameters, so as to optimize detection performance. The invention in particular relates to a configuration in which the analysed gas contains a plurality of gas species, absorbing light in the same spectral band.

### SUMMARY OF THE INVENTION

A first subject of the invention is a method for parameterizing a photoacoustic detector, the photoacoustic detector comprising:
a measurement chamber, intended to be filled by a gas, the gas containing at least one target gas species whose concentration is to be determined;
a laser source, configured to illuminate the gas, the emission power and/or wavelength of the laser source being modulated, the emission power and its temporal modulation being defined by at least one illumination parameter;
an acoustic transducer, configured to form a detection signal or a plurality of successive detection signals, each detection signal being representative of a modulation of a pressure in the measurement chamber, under the effect of the modulation of the laser source;
a processing unit, configured to demodulate each detection signal, according to a demodulation parameter, and to estimate the concentration of the target gas species,
   wherein:
each illumination parameter and/or each demodulation parameter form acquisition parameters respectively associated with each detection signal;
the method comprises a parameterizing phase, implemented by the processing unit or by a parameterizing unit, comprising the following steps:
   (a) defining a measurement error as a function of at least one acquisition parameter;
   (b) determining at least one acquisition parameter minimizing the measurement error;
   (c) for each detection signal, selecting each acquisition parameter determined in step (b).

By determining an acquisition parameter, what is meant is determining a value of the acquisition parameter or of a type of acquisition parameter: it may in particular be a question of a value of an illumination parameter or of a type of demodulation parameter.

According to one possibility:
the processing unit is configured to estimate the concentration of the target gas species using a plurality of detection signals;
at least one acquisition parameter of one detection signal is different from the acquisition parameter of another detection signal.

Thus, each detection signal is obtained differently from at least one other detection signal, or even from more than one other detection signals: the illumination is different and/or the demodulation is different.

according to one possibility:
in step a), the measurement error depends on the concentration of the target gas species;
in step b), the error is minimized for a plurality of ranges of concentrations of the target gas species;
in step c), at least one acquisition parameter is different for two ranges of concentrations of the target gas species.

According to one possibility, for each detection signal, the acquisition parameters comprise at least:
an emission power of the laser source;
and/or an amplitude of modulation of the emission power of the laser source;
and/or a demodulation harmonic of the detection signal.

The demodulation harmonic may be selected from a first harmonic, at the modulation frequency, or a second harmonic, at two times the modulation frequency.

According to one possibility:
the processing unit takes into account two detection signals to estimate the concentration of the target gas species;
each detection signal is demodulated using the first harmonic;
the illumination parameters for each detection signal are different. The emission power and/or the modulation amplitude of the emission power may be different for each detection signal.

According to one possibility, steps a) to c) are implemented using at least two detection signals demodulated by the processing unit to estimate the concentration of the target gas species.

Step c) may be implemented using response functions established for each gas species, as a function of at least one acquisition parameter.

According to one embodiment, the gas contains the target gas species and an interfering gas species, the target gas species and the interfering gas species absorbing light in the same absorption spectral band. The measurement error may depend on the concentration of the target gas species and on the concentration of the interfering gas species.

According to one embodiment, the measurement error depends on the concentration of the target gas species and on the concentration of the interfering gas species.

According to one embodiment, step c) is implemented using response functions established for the target gas species and for the interfering gas species, as a function of at least one acquisition parameter.

A second subject of the invention is a photoacoustic detector, comprising:
a measurement chamber, configured to be filled by a gas, the gas containing at least one target gas species whose concentration is to be determined;
a laser source, configured to illuminate the gas, the emission power and/or wavelength of the laser source being modulated, the emission power of the laser source and its temporal modulation being defined by at least one illumination parameter;
an acoustic transducer, configured to form a detection signal or a plurality of successive detection signals, each detection signal being representative of a modulation of a pressure in the measurement chamber, under the effect of the modulation of the laser source;
a processing unit, configured to demodulate each detection signal, so as to estimate the concentration of the target gas species, the demodulation of the signal being defined by a demodulation parameter;
wherein an acquisition parameter, selected from an illumination parameter and/or a demodulation parameter, is defined by implementing steps a) to c) of a method according to the first subject of the invention.

A third subject of the invention is a photoacoustic detector, comprising:
a measurement chamber, configured to be filled by a gas, the gas containing at least one target gas species the concentration of which it is desired to determine;
a laser source, configured to illuminate the gas, the emission power and/or wavelength of the laser source being modulated, the emission power of the laser source and its temporal modulation being defined by at least one illumination parameter;
an acoustic transducer, configured to form a plurality of successive detection signals, each detection signal being representative of a modulation of a pressure in the measurement chamber, under the effect of the modulation of the laser source;
a processing unit, configured to demodulate each detection signal, to estimate the concentration of the target gas species, the demodulation of the signal being defined by a demodulation parameter,
wherein an acquisition parameter, selected from an illumination parameter and/or a demodulation parameter, is different for two successive detection signals.

A fourth subject of the invention is a method for estimating a concentration of a target gas species, using a photoacoustic detector according to the second or third subject of the invention, the method comprising:
(i) illuminating the gas occupying the measurement chamber using the laser source, in a manner dependent on an illumination parameter;
(ii) during step (i), forming a detection signal by means of the acoustic transducer;
(iii) demodulating one or more detection signals, each detection signal being demodulated in a manner dependent on a demodulation parameter, so as to estimate a concentration of the target gas species,
   the method being such that:
each illumination parameter and each demodulation parameter form acquisition parameters of each detection signal;
the acquisition parameters of each detection signal are defined for various concentration ranges of the target gas species;
   the method comprises reiterating steps (i) to (iii), so that
in a first iteration, the acquisition parameters are initialized arbitrarily or in a manner dependent on a presumption relating to the concentration of the target gas species;
in a second iteration, the acquisition parameters are selected depending on the concentration of the target gas species resulting from the preceding iteration.

The invention will be better understood on reading the disclosure of the exemplary embodiments presented, in the remainder of the description, with reference to the figures listed below.

### FIGURES

FIG. 1 illustrates one example of a photoacoustic detector.

FIG. 2A shows electro-optical characteristics of a laser source. It is here a question of the optical power of a laser beam emitted by the laser source (left-hand y-axis—unit mW) and of the wavenumber of the laser beam (right-hand y-axis: unit cm⁻¹) as a function of a supply current of the laser source.

FIG. 2B shows the absorption spectral bands of two gas species as a function of the wavenumber (x-axis—cm⁻¹). The y-axis corresponds to a linear absorption coefficient (y-axis—cm⁻¹).

FIG. 3 shows a variation in a relative error

$$\frac{{σ}_{det}}{{c}_{det}} ( y - axis )$$

as a function of the concentration c_{det} of a target gas species (x-axis—ppm), and also the variation in various components of the relative error.

FIG. 4A shows a variation in a relative error

$$\frac{{σ}_{det}}{{c}_{det}} ( y - axis )$$

as a function of the concentration c_{det} of a target gas species (x-axis—cm⁻¹), for various acquisition configurations.

FIG. 4B shows a variation in the DC component (left-hand y-axis—unit A (Ampere) and in the amplitude of the modulation component (right-hand y-axis—unit A) of the supply current of a laser as a function of the concentration c_{det} of a target gas species (x-axis—ppm).

FIG. 4C shows a variation in a response coefficient (greyscale) of a photoacoustic detector for one gas species, in this case GB, as a function of the amplitude of the DC component (y-axis—unit A) and of the amplitude of the modulation component (x-axis—unit A) of the supply current of a laser.

FIG. 4D shows a variation in a response coefficient (greyscale) of a photoacoustic detector for another gas species, in this case CO₂, as a function of the amplitude of the DC component (y-axis—unit A) and of the amplitude of the modulation component (x-axis—unit A) of the supply current of a laser.

FIG. 5A shows a ratio of a measurement error (y-axis) as a function of the concentration of a target species (x-axis—ppm) when different respective acquisition parameters are taken into account.

FIG. 5B shows a variation in the relative measurement error (y-axis) as a function of the concentration of a target species (x-axis—ppm), for two measurement configurations.

FIG. 6 schematically shows the main steps of a method according to the invention.

### DESCRIPTION OF PARTICULAR EMBODIMENTS

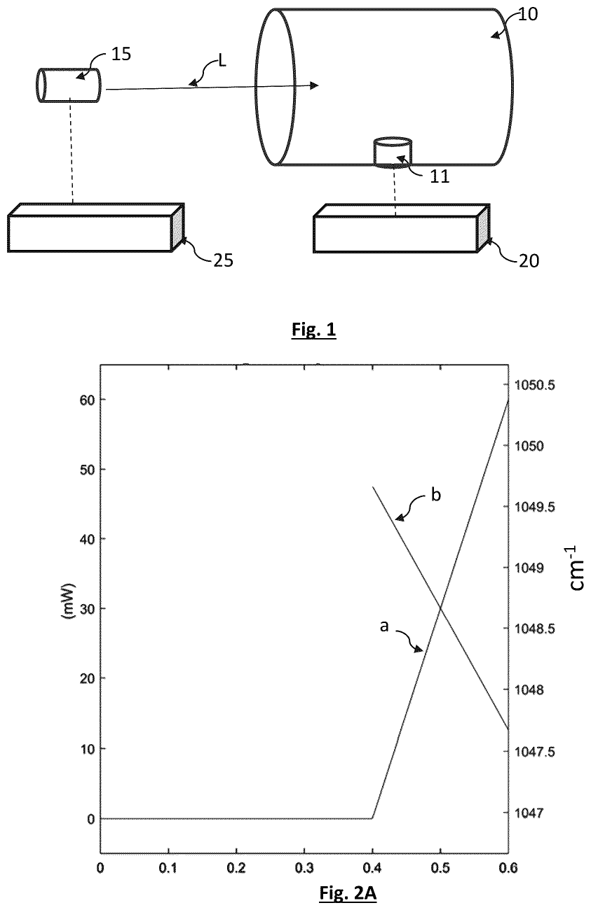

FIG. 1 shows a photoacoustic detector 1. The device comprises a measurement chamber 10 configured to be occupied by a gas to be analysed. The measurement chamber 10 is configured to be exposed to a laser beam L that is amplitude-modulated and/or frequency-modulated at a modulation frequency ƒ. The laser beam L is emitted at a wavelength corresponding to an absorption wavelength of a gas species liable to be present in the gas. Under the effect of the absorption, the illuminated gas heats up, the heating being modulated at the modulation frequency of the laser beam. The modulated heating leads to a succession of compressions/expansions of the gas species. This leads to a pressure variation in the measurement chamber. The laser beam is emitted by one or more laser sources 15.

The device comprises an acoustic measurement transducer 11 for measuring a variation ΔP(t) in the pressure in the measurement chamber under the effect of the modulation of the laser beam. The pressure variation ΔP(t) is modulated at the modulation frequency ƒ.

The laser is for example a quantum cascade laser (QCL), this type of laser being well suited to integration into compact measurement devices. The emission wavelength is in the infrared, typically between 3 and 12 μm. Many gas species have absorption lines in this spectral range.

The device comprises a processing unit 20, configured to process the signal delivered by the detector or by each detector, depending on processing parameters, and to estimate a concentration of the gas species. The processing unit may notably comprise a microprocessor.

The device may comprise a control unit 25, configured to control emission parameters of the laser, for example optical power or amplitude of the modulation.

The emission wavelength and power of the laser 15 are controlled via temperature and supply current I. The latter has a DC component I₀ (offset current) and a modulation component I₁, modulated at the frequency w. Thus:

$$I ( t ) = {I}_{0} + {I}_{1} cos ( wt ) \qquad ( 1 )$$

The processing unit is connected to the measurement transducer and to the optional reference transducer. The processing unit is configured to form and process a detection signal S(t) representative of the pressure variation ΔP(t) in the measurement chamber.

The detection signal may be expressed in the form:

$$S ( t ) = kP ( t ) β ( t ) \qquad ( 2 )$$

where:
k (mV·cm·W⁻¹) is a response coefficient of the detector for the gas species in question;
P(t) (W) is the optical power of the laser beam;
B(t) (cm⁻¹) is the absorption of the gas at the emission wavelength of the laser.

The detection signal S(t) contains an offset signal S⁰ to which are added harmonics of various orders:

$$S ( t ) = {S}^{0} + {S}^{1} cos ( wt ) + {S}^{2} cos ( 2 wt ) \qquad ( 3 )$$

where S^{j} is the harmonic of order j. Each harmonic corresponds to j times the modulation frequency, where j is a positive integer. Only the first two harmonics feature in Expression (3).

The first harmonic S¹ may be considered to be representative of the first derivative of the absorption of the gas species with respect to wavelength. The second harmonic S² may be representative of the second derivative of the absorption of the gas species with respect to wavelength, assuming a linear variation in the absorption coefficient of the molecule in the modulation applied.

The processing unit is configured to demodulate the detection signal, so as to extract the first harmonic or the second harmonic, or a higher-order harmonic.

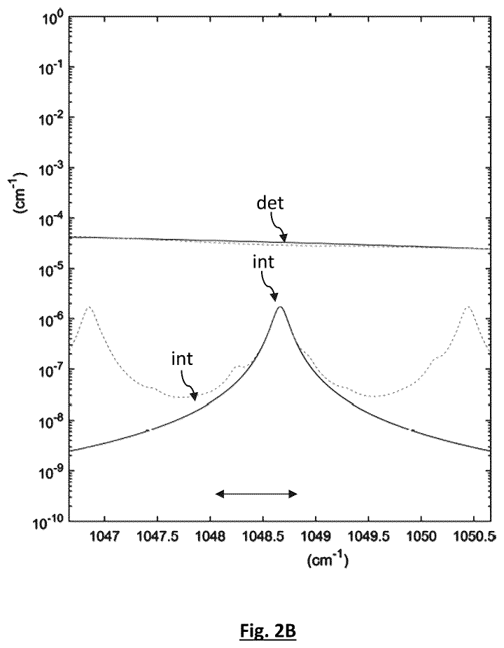

FIG. 2A shows the variation in the laser emission power of one example of a QCL laser source (curve a: left-hand y-axis—unit mW) as a function of the supply current I(t) (x-axis—unit A) and also the variation in the wavenumber of the emitted light beam (curve b: right-hand y-axis—unit cm⁻¹) as a function of I(t). It may be seen that the modulation of the supply current I(t) causes both a modulation of the emission power and of the wavenumber. The laser supply threshold is 0.4 A.

FIG. 2B shows two absorption spectra of two gas species liable to be present in a gas to be detected, the latter typically being air. The y-axis corresponds to an absorption coefficient (cm⁻¹) and the x-axis represents wavenumber (cm⁻¹). The two gas species in question exhibit significant absorption in the same absorption spectral band.

These two gas species include a gas species to be detected, called the target gas species, of concentration c_{det} in the analysed gas, and a gas species, called the interfering gas species, of concentration cᵢₙₜ in the analysed gas. In the example shown, the gas species to be detected is Sarin gas (NATO designation GB) with a concentration of 1 ppm, and the interfering gas species is CO₂ with a concentration of 500 ppm. The dotted curve represents the absorption spectrum of CO₂, it being possible for the latter to be modelled, in a narrow spectral band, of the order of 1 cm⁻¹, by a Lorentzian function (solid curve). The double-headed arrow shows one example of variation in the wavenumber during the modulation of the supply current of the laser.

In this example there are two gas species: a “target” species to be detected mixed with an interfering species. In order to lower the detection limit, N successive detection signals Sᵢ may be acquired, N being greater than or equal to 2. Lowering the detection limit by accumulating detection signals is a known approach.

Each detection signal Sᵢ is parameterized by acquisition parameters, which affect illumination of the gas by the laser and processing of the detection signal, and more specifically the demodulation. The acquisition parameters comprise:
the amplitude of the offset current I_{0,i};
the amplitude of the modulation current I_{1,i};
the harmonic hᵢ taken into account during the demodulation: first harmonic or second harmonic, or higher-order harmonic. The value of hᵢ is j, where j is the order of the harmonic previously defined in conjunction with (3).

One important aspect of the invention is that at least two detection signals may be acquired taking into account at least one different acquisition parameter.

Each detection signal Sᵢ may be described by expression (2), assuming linearity with respect to the concentrations c_{det} and cᵢₙₜ

$${S}_{i} = {k}_{det , i} ( {I}_{0 , i} , {I}_{1 , i} , {h}_{i} ) {c}_{det} + {k}_{int , i} ( {I}_{0 , i} , {I}_{1 , i} , {h}_{i} ) {c}_{int} \qquad ( 4 )$$

where k_{det,i} and k_{int,i} are the response coefficients of the detector for the acquisition parameters (I_{0,i}, I_{1,i}, hᵢ), in respect of the target species and of the interfering species, respectively.

By taking into account N detection signals, a direct model is obtained:

$$[ \begin{matrix}{S}_{1} \\ ⋮ \\ {S}_{N}\end{matrix} ] = [ \begin{matrix}{k}_{det , 1} & {k}_{int , 1} \\ ⋮ & ⋮ \\ {k}_{det , N} & {k}_{int , N}\end{matrix} ] [ \begin{matrix}{c}_{det} \\ {c}_{int}\end{matrix} ] = G [ \begin{matrix}{c}_{det} \\ {c}_{int}\end{matrix} ] \qquad ( 5 )$$

G is a response matrix of the detector for all of the N parameters respectively associated with each detection signal, of (N, 2) size. The response matrix depends on the acquisition parameters. The concentrations

$$[ \begin{matrix}{c}_{det} \\ {c}_{int}\end{matrix} ]$$

are obtained by inverting the direct model, for example using a least-squares method. The direct model is inverted by the processing unit 20.

The following developments aim to determine a variable σ_{det}, minimization of which makes it possible to define optimum acquisition parameters for the target gas species.

The variable σ_{det} (unit ppm) is an error in the estimation of the concentration c_{det}·σ_{det} has three components, which are described below:
σₑ is the variance of the noise of the measurement pipeline, which comprises the acoustic transducer 15, the demodulation implemented by the processing unit, and the analogue-to-digital conversion. The noise of the measurement chain is considered to have a Gaussian distribution, of variance σₑ. The variance σₑ is independent of the concentration of the gas species. The noise of the measurement pipeline is an additive term in the detection signal. σₑ may for example be set equal to 10 uV.
σ₁ (unit mV) corresponds to the measurement noise resulting from the supply of electrical power to the source of laser light. The noise σ₁ has two components, which respectively correspond to the DC component I₀ and to the modulation component I₁.

By differentiating (2) with respect to I₀ and to I₁, and by taking into account a maximum value cᵢₙₜ^{max} of the interfering gas species, expressions (6) and (7) are obtained. cᵢₙₜ^{max} is determined beforehand. It is a question of a value of a maximum

$${σ}_{{I}_{0}} = {σ}_{s , {I}_{0}} ( \vert \frac{\partial {k}_{det}}{\partial {I}_{0}} \vert {c}_{det} + \vert \frac{\partial {k}_{int}}{\partial {I}_{0}} \vert {c}_{int}^{max} ) \qquad ( 6 )$$

$${σ}_{{I}_{1}} = {σ}_{s , {I}_{1}} ( \vert \frac{\partial {k}_{det}}{\partial {I}_{1}} \vert {c}_{det} + \vert \frac{\partial {k}_{int}}{\partial {I}_{1}} \vert {c}_{int}^{max} ) \qquad ( 7 )$$

$$and$$

$${σ}_{I} = \sqrt{{σ}_{{I}_{0}}^{2} + {σ}_{{I}_{1}}^{2}} \qquad ( 8 )$$

σ_{s,I}_{₀} and σ_{s,I}_{₁} are the variances of the noises associated with the components I₀ and I₁, respectively, these noises being considered to have a centred Gaussian distribution. It is for example possible to set σ_{s,I}_{₀}=2 mA and σ_{s,I}_{₁}==1 mA.

In the case of CO₂ in ambient air, cᵢₙₜ^{max}=10000 ppm. This concentration is to be compared with the concentrations usually encountered in unpolluted air, outside (500 ppm) or in a closed inhabited room (2000 ppm).
εᵢₙₜ is an additive noise resulting from the presence of the interfering species. It is not a statistical noise, but an additive component, considered to be a bias.

$${ϵ}_{int} = \vert {k}_{int} \vert {c}_{int}^{max} \qquad ( 9 )$$

The three components σ₁, σₑ and ϵᵢₙₜ are combined to form σ_{det}, according to:

$${σ}_{det} = \frac{\sqrt{\frac{{σ}_{I}^{2} + {σ}_{e}^{2}}{N}} + {ϵ}_{int}}{{k}_{det}} \qquad ( 10 )$$

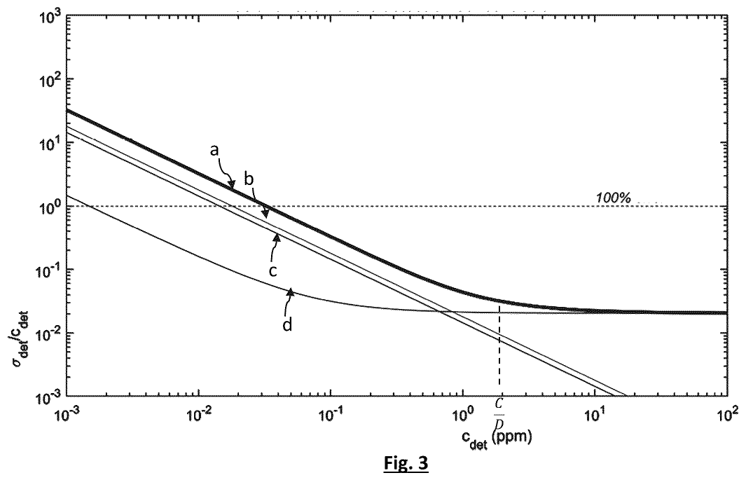

FIG. 3 shows (curve a) a ratio of the relative error

$$\frac{{σ}_{det}}{{c}_{det}} ( y - axis )$$

as a function of c_{det} (x-axis—unit ppm), taking into account N=1, h=1 (first harmonic), and I₀=0.44 A, I₁=0.048 A.

FIG. 3 also shows various contributions to σ_{det}/c_{det}:
curve b: ∈ᵢₙₜ/c_{det}, a function of c_{det}
curve c: σₑ/c_{det}, as a function of c_{det}
curve d: σ₁/c_{det}, as a function of c_{det}

FIG. 3 also shows a 100% curve, for which the relative error

$$\frac{{σ}_{det}}{{c}_{det}} = 1 ,$$

forming a limit of use. It is considered to not be conceivable to take measurements for

$$\frac{{σ}_{det}}{{c}_{det}} \geq 1$$

It is possible to define two ranges on the curve plotting the relative error σ_{det}/c_{det} as a function of c_{det}: in a first range, corresponding to low concentrations c_{det}, σ_{det}/c_{det} tends toward σ_{det}/c, this meaning that c_{det} tends toward a constant C, such that

$$C = \frac{\sqrt{{σ}_{e}^{2} + {( {c}_{int}^{max} ( {σ}_{s , {I}_{0}} \vert \frac{\partial {k}_{int}}{\partial {I}_{0}} \vert + {σ}_{s , {I}_{1}} \vert \frac{\partial {k}_{int}}{\partial {I}_{1}} \vert ) )}^{2}} + {ϵ}_{int}}{{k}_{det}} \qquad ( 11 )$$

In a second range, which corresponds to high concentrations c_{det}, the relative error σ_{det}/c_{det} tends toward another constant D, such that:

$$D = \frac{{σ}_{s , {I}_{0}} \vert \frac{\partial {k}_{det}}{\partial {I}_{0}} \vert + {σ}_{s , 1} \vert \frac{\partial {k}_{det}}{\partial {I}_{1}} \vert}{{k}_{det}} \qquad ( 12 )$$

At high concentrations, the predominant source of error is σ₁/c_{det},

It is possible to define a limit concentration c_{det}*, between the low concentrations and the high concentrations, such that:

$${c}_{det}^{*} \approx \frac{C}{D} S$$

By taking into account N detection signals Sᵢ respectively parameterized by at least one different acquisition parameter, it is possible to write

$$[ \begin{matrix}{σ}_{det}^{2} & {σ}_{det , int}^{2} \\ {σ}_{det , int}^{2} & {σ}_{int}^{2}\end{matrix} ] = {( {G}^{t} {Σ}^{- 1} G )}^{- 1} , \qquad ( 15 )$$

where:
G is the response matrix of the detector, of (N, 2) size, such as defined in conjunction with (5);
σᵢₙₜ is the equivalent of σ_{det} for the species of interest. It is calculated using expressions (6) to (10) taking into account a maximum concentration c_{det}^{max} for the species to be detected;
σ_{det,int} are correlation terms;
Σ is a diagonal measurement covariance matrix, of (N, N) size, such that

$$Σ = [ \begin{matrix}{s}_{1 , 1} & … & 0 \\ ⋮ & ⋱ & ⋮ \\ 0 & … & {s}_{N , N}\end{matrix} ] , \qquad ( 16 )$$

where s_{i,i}=σₑ²+σ_{i,i}²(17). The unit of s_{i,i} is m V².

σ_{i,i}² is the term σᵢ for the measurement of rank i, with 1≤i≤N

In the matrix Σ, crossed terms s_{i,j} with i≠j are zero because the measurements are independent.

From (15), taking into account the fact that the matrix (G^{t}Σ⁻¹G) is invertible for N≥ 2, the following is obtained, for N=2:

$${σ}_{det}^{2} = \frac{\frac{{k}_{int , 1}^{2}}{{s}_{1 , 1}} + \frac{{k}_{int , 2}^{2}}{{s}_{2 , 2}}}{( \frac{{k}_{det , 1}^{2}}{{s}_{1 , 1}} + \frac{{k}_{det , 2}^{2}}{{s}_{2 , 2}} ) ( \frac{{k}_{int , 1}^{2}}{{s}_{1 , 1}} + \frac{{k}_{int , 2}^{2}}{{s}_{2 , 2}} ) - {( \frac{{k}_{det , 1} {k}_{int , 1}}{{s}_{1 , 1}} + \frac{{k}_{det , 2} {k}_{int , 2}}{{s}_{2 , 2}} )}^{2}} \qquad ( 18 )$$

k_{det,i} and k_{int,i} are the responses of the detector for the parameters (I_{0,i}, I_{1,i}, hᵢ) in respect of the target species and of the interfering species, respectively; they were described in conjunction with the expression (5).

In expression (18), σ_{det} depends on c_{det} because of the term σ_{i,j} taken into account in s_{i,i}, (see expressions (17), (10), and (6) to (8)).

Expression (18) makes it possible to define a measurement configuration making it possible to minimize σ_{det}. By measurement configuration, what is meant is the measurement parameters (I_{0,i}, I_{1,i}, hᵢ) for each of the N measurements. In this example, N=1 or N=2.

In other words,

$$( {I}_{0 , i} , {I}_{1 , i} , {h}_{i} ) = {arg min}_{{I}_{0 , i} , {I}_{1 , i} , {h}_{i}} ( {σ}_{det} ) , \qquad ( 19 )$$

the number N being set beforehand.

The optimum acquisition parameters are those that minimize σ_{det}. They are obtained by implementing a minimization algorithm. The minimization algorithm uses stored values of k_{int,i} and k_{det,i}. It will be recalled that when the first harmonic is extracted, it is considered, as a first approximation, that kᵢₙₜ and k_{det} depend on the derivative of the absorption as a function of wavelength. When the second harmonic is extracted, kᵢₙₜ and k_{det} depend on the second derivative of the absorption as a function of wavelength.

Thus, for each harmonic, stored values of kᵢₙₜ and k_{det} are available, stored in the memory 21. The values ∂k_{det}/∂I₀, ∂k_{det}/∂I₁, ∂kᵢₙₜ/∂Iₒ, ∂kᵢₙₜ/∂I₁ may also be stored. The values of kᵢₙₜ and k_{det} or their derivatives with respect to I₁ or I₀ are obtained because the emission parameters of the laser source as a function of I₁ and I₀ are known, these emission parameters being wavenumber and radiant power (see curve in FIG. 2A).

The input data of the algorithm are cᵢₙₜ^{max} or a range of variation of cᵢₙₜ, a range of variation of c_{det}, σₑ, σ_{s,l}_{₀} and σ_{s,j}_{₁}, these values being set by the user depending on the device used.

The input data may also comprise a range of variation of I₁, of I₀, of N and also the harmonics potentially usable to demodulate the detection signal: harmonic of order 1, of order 2 or optionally of higher order.

### Example of Application

Expression (18) was used to define optimum measurement configurations taking into account GB (sarin gas) and CO₂ as target gas species and interfering gas species. Various configurations were tested. A single measurement (N=1) or two successive measurements (N=2) were taken in each configuration.

When N=1, σ_{det} was calculated using (10). When N=2, σ_{det} was calculated using (18), assuming at least one parameter of each of the N measurements to be different. Five configurations were tested:
configuration 1: N=1−measurement taking into account the first harmonic h₁;
configuration 2: N=1−measurement taking into account the second harmonic h₂;
configuration 3: N=2−measurements taking into account the first harmonic h₁;
configuration 4: N=2−measurements taking into account the second harmonic h₂;
configuration 5: N=2−measurements taking into account the first and the second harmonics h₁ and h₂;
wavenumber of the laser: 1049.665 cm⁻¹;
optical power of the laser dependent on the supply current with a slope of 0.3 W/A (see curve a of FIG. 2A); this corresponds to the characteristics of a commercial QCL laser.
wavenumber of the laser beam dependent on the supply current with a slope of −10 cm⁻¹/A. (see curve b of FIG. 2A). It is also a question of a characteristic considered to be standard for a commercial QCL laser;
I₀ varying between 0.4 and 0.6 A, with 500 regularly spaced discretization increments;
I₁ varying between 0.001 and 0.05 A with 250 regularly spaced discretization increments;
cᵢₙₜ^{max}=10⁴ ppm;
σₑ=10 μV;
σ_{s,l}_{ₒ}=2 mA;
σ_{s,I}_{₁}=1 mA.

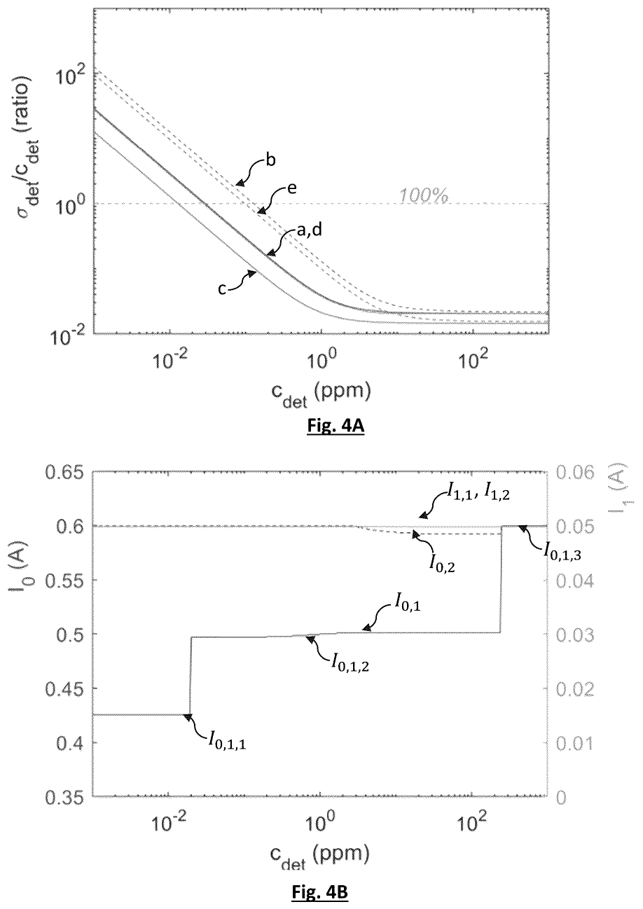

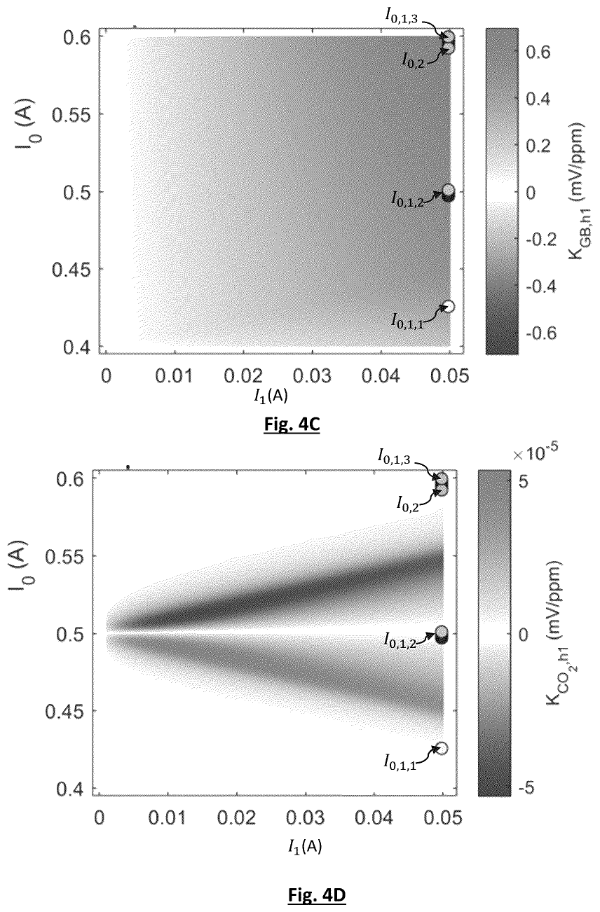

FIG. 4A shows the relative error σ_{det}/c_{det} as a function of c_{det} for the various tested configurations: curve a: configuration 1; curve b: configuration 2; curve c: configuration 3; curve d: configuration 4; curve e: configuration 5. Curves a and d, corresponding to configurations 1 and 4, respectively, are superposed.

FIG. 4A also shows a 100% curve, for which

$$\frac{{σ}_{det}}{{c}_{det}} = 1 ,$$

forming a limit of use. It is considered to not be conceivable to take measurements for

$$\frac{{σ}_{det}}{{c}_{det}} \geq 1.$$

From the results shown in FIG. 4A, it may be seen that the best configuration is the third configuration (curve c), for which the ratio σ_{det}/c_{det} corresponding to the relative measurement error, is minimal for all the concentrations c_{det}. The optimum configuration corresponds to two successive measurements, each taken by demodulating the detection signal using the first harmonic.

For high concentrations, the fifth configuration (curve e) also has a satisfactory performance in terms of relative error.

FIG. 4B shows the optimum currents I_{0,1}, I_{0,2}, I_{1,1}, I_{1,2} for the third configuration, as a function of the concentration c_{det}. It may be seen that the optimum currents, i.e. the currents that minimize σ_{det}/c_{det}, vary as a function of the concentration c_{det}.

Noteworthy information is that the DC component I₀ of the supply current of the laser varies between two optimum values I_{0,1}, I_{0,2} between the two measurement configurations: a first value I_{0,1} depends on the concentration c_{det}, whereas the second value I_{0,2} may be considered, at least to the first order, to be independent of the concentration c_{det}.

Thus:
for c_{det}≤0.02 ppm, I_{0,1}=I_{0,1,1} 0.425 A;
for 0.02 ppm≤c_{det}≤200 ppm, I_{0,1}=I_{0,1,2}=0.5 A;
for c_{det}≥0.02 ppm, I_{0,1}=I_{0,1,3}=0.6 A.
I_{0,2}=0.6 A, regardless of c_{det}, this corresponding to the maximum optical power.
I_{1,2}=I_{1,2}=0.05 A: regardless of c_{det}, this corresponding to the maximum modulation amplitude taken into account.

Thus, during a measurement, which corresponds here, arbitrarily, to the first measurement, the optimum current I_{0,1} takes three different values I_{0,1,1}, I_{0,1,2} and I_{0,1,3} as a function of the concentration c_{det}. It will be understood that it is equivalent for the current I_{0,1} to remain constant and equal to 0.6 A and for the current I_{0,2} to depend on the concentration c_{det}.

FIGS. 4C and 4D show the various values of the response coefficients as a function of the current I₀ (y-axis) and of I₁ (x-axis). The various values I_{0,1,1}, I_{0,1,2} and I_{0,1,3} and I_{0,2} described in conjunction with FIG. 4B have also been plotted, in light of the fact that the optimum value of I₁ is 0.05 mA for each measurement configuration.

It may be seen that the optimum value of I_{0,2} corresponds to a maximum response coefficient k_{det} for the target gas species (GB) and to a minimum response coefficient kᵢₙₜ for CO₂.

When c_{det}<0.02 ppm, the values I_{0,1}=I_{0,1,1} and I_{0,2} correspond to currents for which the values kᵢₙₜ are respectively opposite. Since the detection signal is formed from the first harmonic, kᵢₙₜ corresponds to the derivative of the absorption of the interfering species (CO₂) with respect to wavelength. The value of I_{0,1,1} is presumed employed because it corresponds to a range of values of kᵢₙₜ in which the derivatives

$$\vert \frac{\partial {k}_{det}}{\partial {I}_{0}} \vert and \vert \frac{\partial {k}_{det}}{\partial {I}_{1}} \vert$$

are low, this contributing to minimizing σ₁ (see expressions (6) to (8)).

When 0.02 ppm≤c_{det}≤200 ppm, the value I_{0,1}=I_{0,1,2} corresponds to a value of kᵢₙₜ close to 0, and to a coefficient k_{det} higher than when c_{det}<0.02 ppm.

When c_{det}≥200 ppm, I_{0,1}≈I_{0,2}.

The results show that recourse to different configurations is more suitable for low concentrations c_{det} (i.e. c_{det}≤200 ppm) than for high concentrations. At high concentrations, i.e. when c_{det}>200 ppm, two measurements are carried out with the same parameters, this amounting to obtaining an improvement, in terms of signal-to-noise ratio, solely related to measurement statistics.

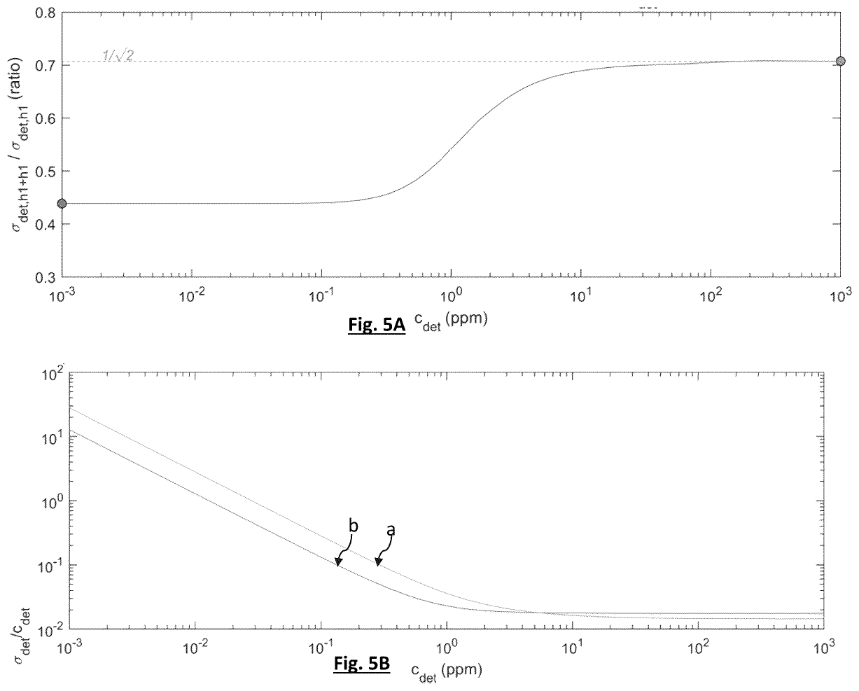

FIG. 5A shows, for various concentrations c_{det} (x-axis), a ratio between:
σ_{det} (h₁, h₁) determined for two measurements based on the first harmonic, taking into account the acquisition parameters described in conjunction with FIGS. 4A to 4D;
σ_{det} (h₁) determined for a single measurement based on the first harmonic, taking into account the optimum acquisition parameters for each concentration c_{det}.

It may be seen that, for high concentrations, the ratio σ_{det}(h₁, h₁)/σ_{det}(h₁) tends toward 1/\sqrt{2} which corresponds to a value due to measurement statistics: it is expected that when the number of measurements is doubled, using the same acquisition parameters, the theoretical improvement in terms of signal-to-noise ratio will be \sqrt{2}.

It is interesting to observe that, for low concentrations, the ratio σ_{det}(h₁, h₁)/σ_{det}(h₁) decreases, getting further from the limit value of 1/\sqrt{2} in particular when c_{det}≤10 ppm, and even more so when c_{det}≤1 ppm. This shows that performing two acquisitions taking two different parameters into account generates an additional improvement with respect to the purely statistical improvement.

FIG. 5B shows the variation, as a function of c_{det} (x-axis), of the ratio

$$\frac{{σ}_{det}}{{c}_{det}} ( y - axis )$$

for the configurations (h₁, h₁), taking into account the same set acquisition parameters for all the values c_{det}. Curve a corresponds to the case where the acquisition parameters defined for c_{det}=10³ ppm were taken into account. Curve b corresponds to the case where the acquisition parameters defined for c_{det}=10⁻³ ppm were taken into account. The advantage of adapting the acquisition parameters depending on the concentration c_{det} is seen here: the optimum parameters at the concentration 10³ ppm (curve a) lead to an increase in the relative error σ_{det}/c_{det} at low concentrations c_{det}. Conversely, the optimum parameters at the concentration 10⁻³ ppm (curve b) lead to an increase in the relative error σ_{det}/c_{det} at high concentrations c_{det}.

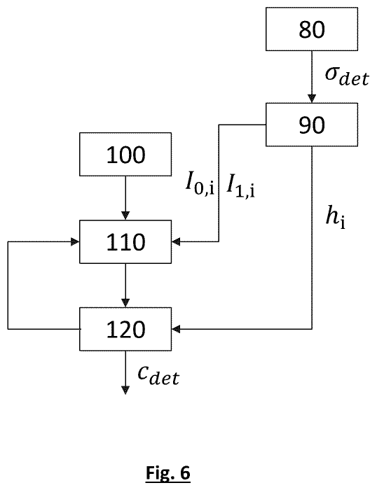

FIG. 6 summarizes the main steps of a method implementing the invention.

In a step 100, a gas mixture, containing at least two gas species, is introduced into a photoacoustic detector.

In a step 110, the gas mixture is subjected to a number N of measurements, each measurement being parameterized by supply parameters of the laser source. In this example, the parameters are the DC component I_{0,i} and the amplitude of the modulation component I_{1,i}.

In a step 120: the detection signal delivered by the detector is demodulated, using a predefined harmonic. The demodulation makes it possible to obtain an estimate of the concentration of each gas species, or of at least one gas species present in the mixture.

Steps 110 and 120 are implemented using acquisition parameters that are predefined, for example for various ranges of expected concentrations of each gas species. The acquisition parameters are established in parameterizing phases 80 and 90, implemented by a parameterizing unit.

In phase 80, values or ranges of values of measurement parameters are defined: illumination parameters of the laser, harmonics used to demodulate the detection signal, maximum number of measurements, ranges of concentrations of each gas species (or maximum value of the concentration of a gas species). This makes it possible to obtain an analytical expression for the measurement error σ_{det}, such as (18).

Step 90 is a step of minimizing the measurement error σ_{det}, so as to identify the optimum acquisition parameters, i.e. the laser supply parameters and/or the demodulation parameters, and in particular the choice of the harmonic. See (19).

It has been observed that the optimum parameters may vary as a function of the concentration of at least one species to be detected, c_{det} in the example described above. A presumption may be made regarding the value of c_{det} to be measured, or at least regarding a range of values, in which case the acquisition parameters are defined depending on this presumption.

When it is not feasible to make a presumption, steps 110 to 120 may be performed iteratively while adjusting, between two successive iterations, the acquisition parameters depending on the obtained concentration c_{det}. In a first iteration, the acquisition parameters are selected arbitrarily or randomly, or on the basis of a presumption. A first estimate of c_{det} is obtained. Steps 110 to 120 are then reiterated, in such a way that the concentration c_{det} of an iteration of rank q-1 is used to select the acquisition parameters of the following iteration of rank q. The iterations succeed one another until a predetermined number of iterations has been carried out or until the value c_{det} has stabilized.

Although described in conjunction with one “target” species to be detected mixed with one interfering species, the method is applicable to estimation of the concentrations of two different target species.

In this case, the parameters are established so as to optimize the detection errors of the two gas species, taking into account a compromise between the detection errors. The cost function to be minimized may for example combine the measurement errors of each gas species.

1. A method for parameterizing a photoacoustic detector, the photoacoustic detector comprising:
a measurement chamber, configured to be filled by a gas, the gas containing at least one target gas species whose concentration is to be determined;
a laser source, configured to illuminate the gas, the emission power and/or wavelength of the laser source being modulated, the emission power and its temporal modulation being defined by at least one illumination parameter;
an acoustic transducer, configured to form a detection signal or a plurality of successive detection signals, each detection signal being representative of a modulation of a pressure in the measurement chamber, under the effect of the modulation of the laser source;
a processing unit, configured to demodulate each detection signal, according to a demodulation parameter, and to estimate the concentration of the target gas species,
wherein:
each illumination parameter and/or each demodulation parameter form acquisition parameters respectively associated with each detection signal;
the method comprises a parameterizing phase, implemented by a parameterizing unit, comprising:
(a) defining a measurement error as a function of at least one of said acquisition parameters;
(b) determining said at least one parameter minimizing the measurement error;
(c) for each detection signal, selecting the acquisition parameter determined in (b).

2. The method according to claim 1, wherein:
the processing unit is configured to estimate the concentration of the target gas species using a plurality of detection signals;
at least one acquisition parameter of one detection signal is different from said acquisition parameter of another detection signal.

3. The method according to claim 1, wherein
in a), the measurement error depends on the concentration of the target gas species;
in b), the error is minimized for a plurality of ranges of concentrations of the target gas species;
in c), at least one acquisition parameter is different for two ranges of concentrations of the target gas species.

4. The method according to claim 1, wherein, for each detection signal, the acquisition parameters comprise at least:
an emission power of the laser source;
and/or an amplitude of modulation of the emission power of the laser source;
and/or a demodulation harmonic of the detection signal.

5. The method according to claim 4, wherein the demodulation harmonic is selected from a first harmonic, at the modulation frequency, or a second harmonic, at two times the modulation frequency.

6. The method according to claim 5, wherein
the processing unit takes into account two detection signals to estimate the concentration of the target gas species;
each detection signal is demodulated using the first harmonic;
the illumination parameters for each detection signal are different.

7. The method according to claim 1, wherein steps a) to c) are implemented using at least two detection signals demodulated by the processing unit to estimate the concentration of the target gas species.

8. The method according to claim 1, wherein step c) is implemented using response functions established for the target gas species, as a function of said at least one acquisition parameter.

9. The method according to claim 1, wherein the gas contains the target gas species and an interfering gas species, the target gas species and the interfering gas species absorbing light in the same absorption spectral band.

10. The method according to claim 9, wherein the measurement error depends on the concentration of the target gas species and on the concentration of the interfering gas species.

11. The method according to claim 9, wherein step c) is implemented using response functions established for the target gas species and for the interfering gas species, as a function of said at least one acquisition parameter.

12. A photoacoustic detector, comprising:
a measurement chamber, configured to be filled by a gas, the gas containing at least one target gas species whose concentration is to be determined;
a laser source, configured to illuminate the gas, the emission power and/or wavelength of the laser source being modulated, the emission power of the laser source and its temporal modulation being defined by at least one illumination parameter;
an acoustic transducer, configured to form a detection signal or a plurality of successive detection signals, each detection signal being representative of a modulation of a pressure in the measurement chamber, under the effect of the modulation of the laser source;
a processing unit, configured to demodulate each detection signal, so as to estimate the concentration of the target gas species, the demodulation of the signal being defined by a demodulation parameter;
a parameterizing unit, configured to implement steps a) to c) of the method according to claim 1, so as to define at least one acquisition parameter, selected from an illumination parameter and/or a demodulation parameter.

13. A Method for estimating a concentration of a target gas species, using a photoacoustic detector according to claim 12, the method comprising:
(i) illuminating the gas within the measurement chamber using the laser source, according to an illumination parameter;
(ii) during step (i), forming a detection signal by means of the acoustic transducer;
(iii) demodulating one or more detection signals, each detection signal being demodulated according to a demodulation parameter, so as to estimate a concentration of the target gas species,
wherein:
each illumination parameter and each demodulation parameter form acquisition parameters of each detection signal;
the acquisition parameters of each detection signal are defined for various concentration ranges of the target gas species;
the method comprises reiterating steps (i) to (iii), so that
in a first iteration, the acquisition parameters are initialized arbitrarily or according to an a priori relative to the concentration of the target gas species;
in a second iteration, the acquisition parameters are selected depending on the concentration of the target gas species resulting from the preceding iteration

14. A Photoacoustic detector, comprising:
a measurement chamber, configured to be filled by a gas, the gas containing at least one target gas species whose concentration is to be determined;
a laser source, configured to illuminate the gas, the emission power and/or wavelength of the laser source being modulated, the emission power of the laser source and its temporal modulation being defined by at least one illumination parameter;
an acoustic transducer, configured to form a plurality of successive detection signals, each detection signal being representative of a modulation of a pressure in the measurement chamber, under the effect of the modulation of the laser source;
a processing unit, configured to demodulate each detection signal, to estimate the concentration of the target gas species, the demodulation of the signal being defined by a demodulation parameter,
wherein an acquisition parameter, selected from an illumination parameter and/or a demodulation parameter, is different for two successive detection signals.

15. A Method for estimating a concentration of a target gas species, using a photoacoustic detector according to claim 14, the method comprising:
(i) illuminating the gas within the measurement chamber using the laser source, according to an illumination parameter;
(ii) during step (i), forming a detection signal by means of the acoustic transducer;
(iii) demodulating one or more detection signals, each detection signal being demodulated according to a demodulation parameter, so as to estimate a concentration of the target gas species,
wherein:
each illumination parameter and each demodulation parameter form acquisition parameters of each detection signal;
the acquisition parameters of each detection signal are defined for various concentration ranges of the target gas species;
the method comprises reiterating steps (i) to (iii), so that
in a first iteration, the acquisition parameters are initialized arbitrarily or according to an a priori relative to the concentration of the target gas species;
in a second iteration, the acquisition parameters are selected depending on the concentration of the target gas species resulting from the preceding iteration
